(19) United States
(12) Patent Application Publication
(10) Pub. No.: US 2026/0061647 A1
(43) Pub. Date: Mar. 5, 2026

(54) HAIR CLIPPER BLADE WITH NODES

(71) Applicant: WAHL CLIPPER CORPORATION, Sterling, IL (US)

(72) Inventors: Jason William WAGNER, Sterling, IL (US); Sam Xueyi ZHANG, Sterling, IL (US)

(21) Appl. No.: 18/820,704

(22) Filed: Aug. 30, 2024

(51) Int. Cl. B26B 19/38; B26B 19/06

(52) U.S. Cl. CPC B26B 19/3846; B26B 19/06

(57) ABSTRACT

A bladeset operationally connected to a hair clipper is provided, the bladeset including a stationary blade and a moving blade configured for reciprocating laterally relative to the stationary blade, where at least one of the stationary blade and the moving blade including a base and a plurality of teeth extending from the base. Each tooth includes a root where the tooth connects to the base, a tip on an opposite side of the tooth from the root, a rear face, and two side faces, each side face including a first projection and a second projection extending from the rear face, the first projection being closer to the tip than the second projection.

### BACKGROUND

The present invention relates generally to electric hair cutting devices, also referred to as hair clippers or hair trimmers employing reciprocating blade action for achieving cutting action, here collectively referred to as hair clippers, more specifically to blades for such clippers, and more particularly to the specific configuration of teeth for such blades.

Conventionally, clipper blades include a stationary or fixed blade, and a moving blade that reciprocates under a drive force relative to the fixed blade. Each blade has a generally planar base, which in the stationary blades is often provided with fastener openings for accommodating fasteners that secure the blade to the clipper. The moving blade is typically clamped against the fixed blade by a spring clip and includes a generally central opening for receiving a drive member.

Common, forward-facing edges of the fixed and moving blades are provided with a plurality of cutting teeth. Depending on the type of cutting action desired, and the target subject to be clipped, including humans, livestock, pets, carpet, etc., the tooth length and configuration may vary, but in most cases the teeth have a box-like transverse cross-section. This cross-sectional configuration extends from a root of the tooth adjacent the base, to an opposing tooth tip. Some tooth geometries and relationships are well suited for bulk removal of hair, while other geometries and relationships are better suited for finer work such as fading and blending.

Barbers or other users of hair clippers prefer feedback from the hair clipper when cutting hair, such as physical or auditory feedback to indicate when hair is being cut. However, traditional hair clippers do not provide sufficient auditory feedback to indicate when hair is being cut. Another problem encountered with conventional clipper bladesets is the hair strands getting pushed out or conversely, the phenomena of so-called “fly aways” or hairs that escape the cutting zone prior to being cut.

Accordingly, there is the need for a hair clipper bladeset which addresses the design problems discussed above, and among other things, provides improved auditory response when the hair clipper is cutting hair.

### SUMMARY

The above-listed need is met or exceeded by the present hair clipper blade with nodes. Each tooth of the hair clipper blade has a blade tip at one end, and an opposite root which connects to a blade base. Also, each tooth of the present blade has two side faces which each include a pair of laterally or transversely projecting projections that advantageously form a node at a point farthest from the side faces of the tooth. A feature of the present blade is that each of the projections define a zone of a distinct rake angle of the tooth. In other words, the teeth have a first rake angle up to the first node of the first projection, and a second, distinct rake angle between the second node and the side face. Optionally, the teeth include additional rake angle sections between the second node and the blade root. Optionally, the teeth can include additional sections having the same or different rake angles than those described herein.

In an embodiment, the first rake angle of the teeth is between 3-45°, and advantageously the first rake angle is approximately 5°. In another embodiment, the second rake angle of the teeth is between 10-60°, and advantageously the second rake angle is approximately 20°. Another feature of the present hair clipper blade is that the side faces of the tooth are scalloped between the nodes, so that an overhead plan profile of the tooth reveals a series of three scallops or concave edges. In an embodiment, arcs defined by these scallops have a smaller diameter closer to the root of the tooth.

The first and second projections, as well as the scalloped profile of the side faces, help retain hair within a cutting zone between the stationary blade and the moving blade, which improves the cutting ability of the stationary blade and the moving blade, as well as allowing for a reduced width of the teeth. Additionally, the present hair clipper blade provides improved auditory feedback to the user of the hair clipper, and helps prevent bundling or clumping of thick hair which is being cut by the hair clipper. Advantageously, the present blade is manufactured using Metal Injection Molding (MIM).

More specifically, a bladeset operationally connected to a hair clipper is provided, the bladeset including a stationary blade and a moving blade configured for reciprocating laterally relative to the stationary blade, where at least one of the stationary blade and the moving blade including a base and a plurality of teeth extending from the base. Each tooth includes a root where the tooth connects to the base, a tip on an opposite side of the tooth from the root, a rear face, and two side faces, each side face including a first projection and a second projection extending from the rear face. The first projection is closer to the tip than the second projection, the first projection including a first node which extends a first distance from the side face and defines a first rake angle α, and the second projection including a second node which extends a second distance from the side face and defines a second rake angle β, such that the second rake angle β is different from the first rake angle α.

In embodiments, the first rake angle α is between approximately 3° and approximately 45° and the second rake angle β is between approximately 10° and approximately 60°. In another embodiment, each side face is scalloped so that, when viewed from the rear face, the side face includes a first concave edge between the tip and the first node, a second concave edge between the first node and the second node, and a third concave edge between the second node and the root. Advantageously, a diameter of the first concave edge is greater than a diameter of the second concave edge, and the diameter of the second concave edge is greater than a diameter of the third concave edge.

In yet another embodiment, at least one of the stationary blade and the moving blade is manufactured using Metal Injection Molding (MIM). Advantageously, the root includes a fillet where the side faces meet the base.

A second embodiment includes a hair clipper including a clipper housing defining a longitudinal axis and a cutting end and a clipper bladeset operationally connected to the cutting end and including a stationary blade and a moving blade configured for reciprocating laterally relative to the stationary blade. At least one of the stationary blade and the moving blade include a base and a plurality of teeth extending from the base, where each of the plurality of teeth includes a root where the tooth connects to the base, a tip on an opposite side of the tooth from the root, a rear face, and two side faces. Each side face has a first projection and a second projection extending from the rear face, the first projection being closer to the tip than the second projection. The first projection includes a first node which extends a first distance from the side and defines a first rake angle α, and the second projection includes a second node which extends a second distance from the side face and defines a second rake angle β, such that the second rake angle β is different from the first rake angle α.

### BRIEF DESCRIPTION OF THE DRAWINGS

FIG. 1A is a top perspective of a hair clipper including an embodiment of the present hair clipper blade;

FIG. 1B is an enlarged, perspective, fragmentary view of the hair clipper blade of FIG. 1A;

FIG. 2A is top plan view of the hair clipper blade of FIG. 1A;

FIG. 2B is an enlarged, fragmentary view of the hair clipper blade of FIG. 2A;

FIG. 3A is bottom plan view of the hair clipper blade of FIG. 1A;

FIG. 3B is an enlarged, fragmentary view of the hair clipper blade of FIG. 3A;

FIG. 4A is front plan view of the hair clipper blade of FIG. 1A; and

FIG. 4B is an enlarged, fragmentary view of the hair clipper blade of FIG. 4A.

### DETAILED DESCRIPTION

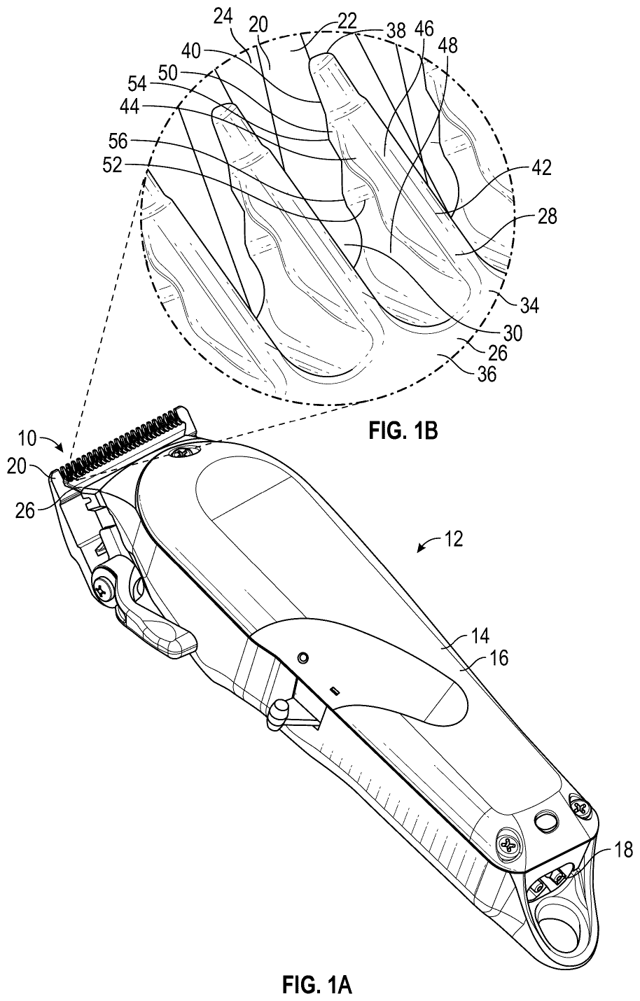

Referring now to FIG. 1A, a hair clipper bladeset is provided and generally designated 10. As known in the art, the bladeset 10 is attached to a hair clipper 12 including a housing 14 having a generally elongate handle 16. As is well known in the art, the housing 14 generally encloses, among other things an electric motor, a drive system, electronic circuitry, and an optional rechargeable battery (all not shown). The housing 14 optionally includes a power cord connection socket 18.

As seen in FIG. 1A, the bladeset 10 includes at least one stationary blade 20 having a plurality of stationary blade teeth 22 defining stationary blade teeth cavities or spaces 24 between adjacent teeth, and at least one moving blade 26 having a plurality of moving blade teeth 28 defining moving blade teeth cavities or spaces 30 between adjacent teeth. The stationary blade 20 is connected to the housing 14 by any suitable fastening technology, such as screws or the like (not shown). The moving blade 26 is configured for laterally reciprocating relative to the stationary blade 20 for cutting hair therebetween in a scissors action, as is well known in the art. Suitable hair clipper bladeset assemblies are disclosed in U.S. Pat. Nos. 5,068,966; 9,545,729 and 10,272,578, the contents of all of which are herein incorporated by reference. To enable hair cutting, the moving blade teeth 28 further include sides or cutting faces that overlap corresponding stationary blade teeth sides or cutting faces during reciprocation, creating a scissors action and cutting hair that has entered the stationary blade teeth cavities 24.

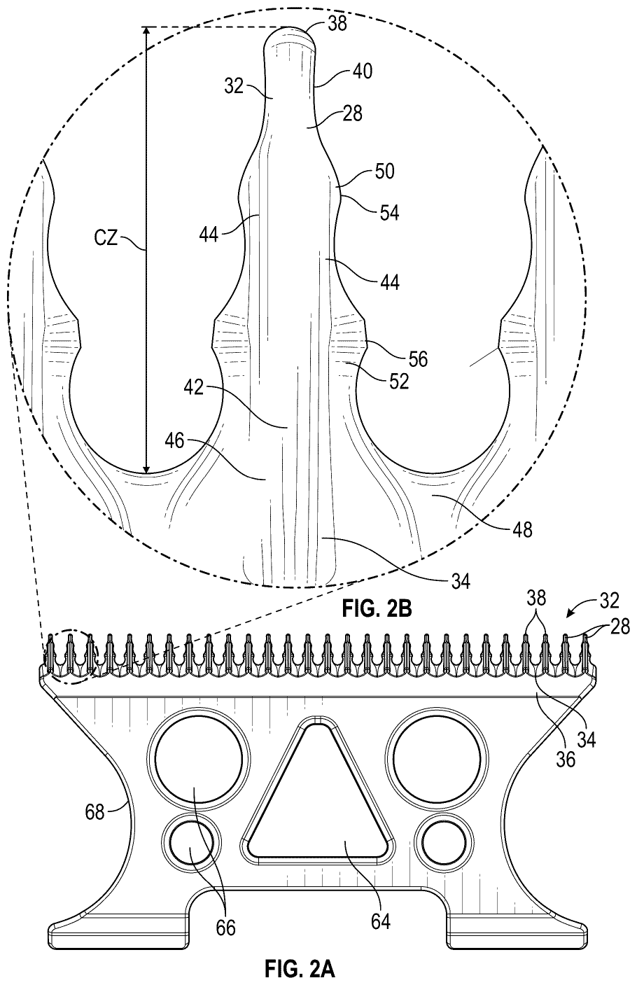

Referring to FIGS. 1B, 2A, 2B, 3A, 3B, 4A, and 4B, an embodiment of a hair clipper blade 32 used for the moving blade 26 of the bladeset 10 is shown, however it is contemplated that the present tooth configuration is adaptable for the stationary blade 20 as well, where the hair clipper blade 32 includes the plurality of teeth 28. Each tooth 28 includes a root 34 where the tooth connects to a base 36 of the hair clipper blade 32, and a tip 38 on an opposite side of the tooth from the root. In an embodiment, the tip 38 is rounded and the smallest width of the tooth 28 is at the tip. Hair which enters a cutting zone CZ between the tip 38 and the root 34 is severed due to the reciprocating action between the hair clipper blade 32 and the stationary blade 18.

The tooth 28 also includes a rear face 40, a front face 42, and side faces 44 which extend between the rear face and the front face, where the side faces are substantially parallel to one another and extend from the base 36 of the blade 32. Additionally, the side faces 44 extend substantially perpendicularly from the rear face 40, and an edge 46 where the side faces 44 meet the front face 42 is rounded. The root 34 includes a fillet 48 where the side faces 44 meet the base 36. While the side faces 44 on each side of the tooth 28 are optionally identical, it is appreciated that the side faces optionally have different configurations.

Each side face 44 includes a first projection 50 and a second projection 52, such that the first projection and the second projection extend from the rear face 40 of the tooth 28 toward the front end 42. The first projection 50 includes a first node 54 which is spaced a first distance D1 from the side face 44, and the second projection 52 includes a second node 56 which is spaced a second distance D2 from the side face. The first distance D1 is between approximately 0.001 inches and approximately 0.015 inches, and the second distance D2 is between approximately 0.005 inches and approximately 0.020 inches, such that the second distance D2 is greater than the first distance D1.

Advantageously, portions of the first and second projections 50, 52 are flush with the rear face 40, and the first projection 50 is closer to the tip 38 of the tooth 28 compared to the second projection 52.

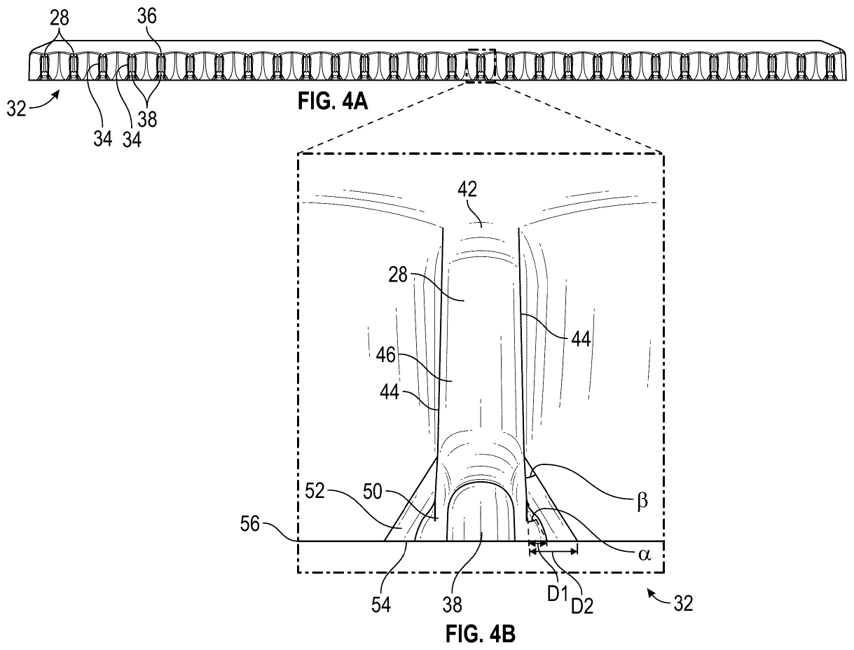

Referring to FIGS. 4A and 4B, the first projection 50 includes a first rake angle α defined between the side face 44 and a surface of the first projection between the first node 54 and the side face. Similarly, the second projection 52 includes a second rake angle β defined between the side face 44 and a surface of the second projection 52 between the second node 56 and the side face. Advantageously, the second rake angle β is greater than the first rake angle α. Inclusion of the first projection 50 and the second projection 52 helps reduce the width of the tooth 28, since the first and second projections 50, 52 help keep hair in within the cutting zone CZ between the tip 38 and the root 34. Each tooth 28 advantageously has a steep angle on the side face 44 near the tip.

In an embodiment, the first rake angle α is between approximately 3° and approximately 45°. Advantageously, the first rake angle α is approximately 5°. In another embodiment, the second rake angle β is between approximately 10° and approximately 60°. Advantageously, the second rake angle β is approximately 20°.

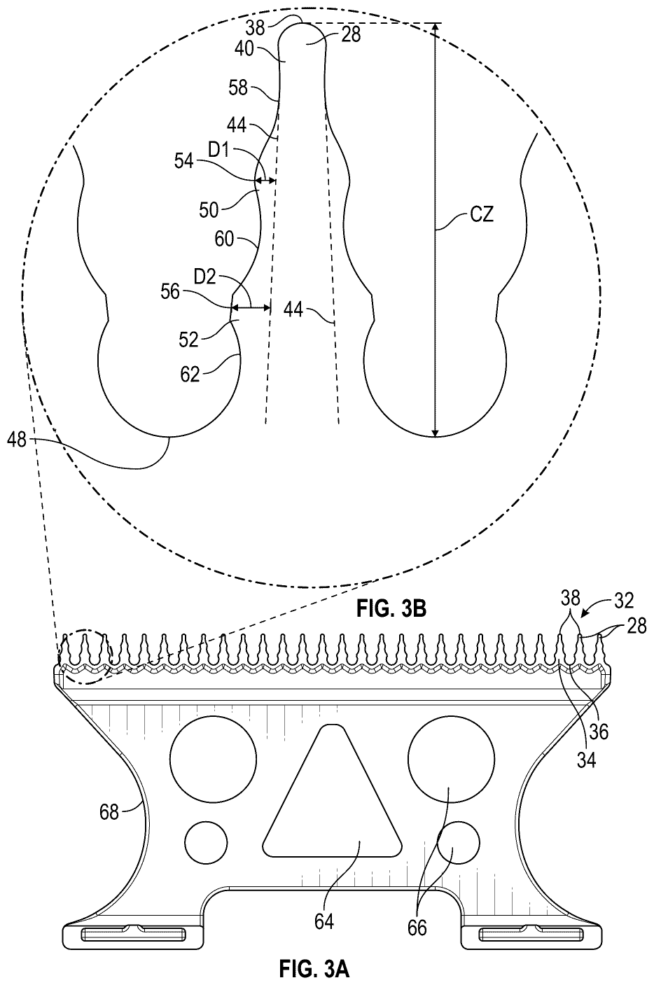

Referring now to FIGS. 3A and 3B, the side faces 44 are scalloped so that, when viewed from the rear face 40, each side face includes a first concave edge 58 which extends between the tip 38 and the first node 54, a second concave edge 60 which extends between the first node 54 and the second node 56, and a third concave edge 62 which extends between the second node 56 and the root 34. Advantageously, the surfaces of the first projection 50 and the second projection 52 are curved in a concave manner between the first and second nodes 54, 56 and the side face. By providing side faces 44 which are scalloped, hair is trapped within the cutting zone CZ, and the hair is pushed toward the stationary blade, thereby improving the cutting action between the blade 32 and the stationary blade 18. Moreover, the side faces 44 help prevent hair from bundling or bunching, which would potentially pull on the hair of a person whose hair is being cut by the hair clipper 12, thus causing discomfort. It is contemplated, however, that side faces 44 could employ other geometries instead of the scalloped shape depicted. For non-limiting example, the side faces 44 may have a saw blade appearance of ramped portions, etc.

In an embodiment, a diameter of the first concave edge 58 is greater than a diameter of the second concave edge 60, and the diameter of the second concave edge is greater than a diameter of the third concave edge 62. Advantageously, the diameter of the third concave edge 62 is between approximately 0.020 inches and approximately 0.040 inches, the diameter of the second concave edge 60 is between approximately 0.030 inches and approximately 0.050 inches, and the diameter of the first concave edge 58 is between approximately 0.060 inches and approximately 0.080 inches.

When cutting hair, the hair clipper 12 advantageously provides audible feedback, in the form of a “crunch”. The present hair clipper blade 32, which includes the side face 44 that is scalloped and which includes the first projection 50 and the second projection 52, provides improved auditory feedback because of the first rake angle α and the second rake angle β provided in the ranges described above. The auditory feedback improves the experience for a user of the hair clipper 12. Additionally, the reduced bundling or clumping of hair which is being cut by the hair clipper 12 improves the comfort for a person whose hair is being cut by the hair clipper.

The blade 32 is optionally made of metal and is advantageously manufacture using Metal Injection Molding (MIM). Additionally, the blade 32 includes a cam follower 64 disposed approximately in the center of the blade, which receives a cam (not shown) within the clipper housing 14. Openings 66 in the blade 32 advantageously reduce the overall weight of the blade 32. In an embodiment, further weight reduction is achieved by the sides 68 of the blade 32 have a half moon shape.

While a particular embodiment of the present hair clipper blade with nodes has been described herein, it will be appreciated by those skilled in the art that changes and modifications may be made thereto without departing from the invention in its broader aspects and as set forth in the following claims.

Unless specifically stated or obvious from context, as used herein, the term “approximately” is understood as within a range of normal tolerance in the art, for example within 2 standard deviations of the mean. Approximately (use of the term “approximately”) is optionally be understood as within 20%, 19%, 18%, 17%, 16%, 15%, 14%, 13%, 12% 11%, 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “approximately.”

All references, including publications, patent applications, and patents cited herein are hereby incorporated by reference to the same extent as if each reference were individually and specifically indicated to be incorporated by reference and were set forth in its entirety herein.

The term “electric hair cutting device” as used herein includes any electric hair cutting device that includes a motor which drives a moving blade to cut hair, including but not limited to hair clippers, hair trimmers, and electric shavers. The terms “hair clipper” and “hair trimmer” are used interchangeably unless otherwise noted, and do not limit the scope or applicability of the invention herein to either particular variant.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Embodiments of this invention are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A bladeset operationally connected to a hair clipper, the bladeset comprising:
a stationary blade and a moving blade configured for reciprocating laterally relative to said stationary blade;
at least one of said stationary blade and said moving blade including a base and a plurality of teeth extending from said base, each said tooth comprising:
a root where said tooth connects to said base;
a tip on an opposite side of said tooth from said root;
a rear face; and
two side faces, each said side face including a first projection and a second projection extending from said rear face, said first projection being closer to said tip than said second projection, said first projection including a first node which extends a first distance from said side face and defines a first rake angle α, and said second projection including a second node which extends a second distance from said side face and defines a second rake angle β, such that said second rake angle β is different from said first rake angle α.

2. The bladeset of claim 1, wherein said first rake angle α is between approximately 3° and approximately 45°.

3. The bladeset of claim 1, wherein each said side face is scalloped so that, when viewed from said rear face, said side face includes:
a first concave edge between said tip and said first node;
a second concave edge between said first node and said second node; and
a third concave edge between said second node and said root.

4. The bladeset of claim 3, wherein a diameter of said first concave edge is greater than a diameter of said second concave edge, and said diameter of said second concave edge is greater than a diameter of said third concave edge.

5. The bladeset of claim 1, wherein said at least one of said stationary blade and said moving blade is manufactured using Metal Injection Molding (MIM).

6. The bladeset of claim 1, wherein said root includes a fillet where said side faces meet said base.

7. The bladeset of claim 1, wherein said second rake angle β is between approximately 10° and approximately 60°.

8. The bladeset of claim 1, wherein said second distance is greater than said first distance.

9. A hair clipper comprising:
a clipper housing defining a longitudinal axis and a cutting end; and
a clipper bladeset operationally connected to said cutting end and including a stationary blade and a moving blade configured for reciprocating laterally relative to said stationary blade;
at least one of said stationary blade and said moving blade including a base and a plurality of teeth extending from said base, said plurality of teeth comprising:
a root where said tooth connects to said base;
a tip on an opposite side of said tooth from said root;
a rear face; and
two side faces, each said side face including a first projection and a second projection extending from said rear face, said first projection being closer to said tip than said second projection, said first projection including a first node which extends a first distance from said side and defines a first rake angle α, and said second projection including a second node which extends a second distance from said side face and defines a second rake angle β, such that said second rake angle β is different from said first rake angle α.

10. The hair clipper of claim 9, wherein said first rake angle α is between approximately 3° and approximately 45°.

11. The hair clipper of claim 9, wherein each said side face is scalloped so that, when viewed from said rear face, said side face includes:
a first concave edge between said tip and said first node;
a second concave edge between said first node and said second node; and
a third concave edge between said second node and said root.

12. The hair clipper of claim 11, wherein a diameter of said third concave edge is greater than a diameter of said second concave edge, and said diameter of said second concave edge is greater than a diameter of said first concave edge.

13. The hair clipper of claim 9, wherein said at least one of said stationary blade and said moving blade is manufactured using Metal Injection Molding (MIM).

14. The hair clipper of claim 9, wherein said root includes a fillet where said side faces meet said base.

15. The hair clipper of claim 9, wherein said second rake angle β is between approximately 10° and approximately 60°.

16. The hair clipper of claim 9, wherein said second distance is greater than said first distance.
